(19) United States
(12) Patent Application Publication
(10) Pub. No.: US 2008/0225257 A1
(43) Pub. Date: Sep. 18, 2008

(54) Optical integrator system, illumination optical apparatus, exposure apparatus, and device manufacturing method

(75) Inventor: Naonori Kita, Ageo (JP)

Correspondence Address: OLIFF & BERRIDGE, PLC, P.O. BOX 320850, ALEXANDRIA, VA, 22320-4850, US

(73) Assignee: NIKON CORPORATION, TOKYO (JP)

(21) Appl. No.: 12/068,828

(22) Filed: Feb. 12, 2008

Related U.S. Application Data
(60) Provisional application No. 60/906,519, filed on Mar. 13, 2007.

(51) Int. Cl. G03B 27/54; G02B 27/30

(52) U.S. Cl. 355/67; 359/641

(57) ABSTRACT

An optical integrator system comprises a first optical integrator including a plurality of first wavefront dividing elements arranged in juxtaposition along a predetermined direction, and a second optical integrator including a plurality of second wavefront dividing elements arranged in juxtaposition along the predetermined direction, which are arranged in order from the entrance side of light. The first wavefront dividing elements are so constructed that rays obliquely incident to a center on the optical axis of an entrance surface are emitted in parallel with the optical axis. The second wavefront dividing elements are so constructed that rays obliquely incident to a center on the optical axis of an entrance surface are emitted obliquely to the optical axis.

### CROSS-REFERENCE TO RELATED APPLICATIONS

This application is based upon and claims the benefit of priorities from U.S. Provisional Application No. 60/906,519, filed on Mar. 13, 2007, the entire contents of which are incorporated herein by reference.

### BACKGROUND

1. Field

An embodiment of the present invention relates to an optical integrator system, an illumination optical apparatus, an exposure apparatus, and a device manufacturing method. More particularly, an embodiment of the present invention relates to an optical integrator system applicable to illumination optical apparatus in exposure apparatus for manufacturing devices (electronic devices and others) such as semiconductor devices, imaging devices, liquid-crystal display devices, and thin-film magnetic heads by lithography.

2. Description of the Related Art

In an exposure apparatus, a beam emitted from a light source is incident to a fly's eye lens as an optical integrator to form a secondary light source (a light intensity distribution formed on an illumination pupil) consisting of a large number of light sources on the rear focal plane of the fly's eye lens. Beams from the secondary light source travel through an aperture stop and a condenser lens to illuminate a mask with a predetermined pattern in a superimposed manner. Light having passed through the pattern of the mask travels through a projection optical system to be focused on a wafer. In this manner the mask pattern is projected (or transferred) onto the wafer to effect projection exposure thereof.

A cylindrical micro fly's eye lens consisting of a pair of fly's eye members having cylindrical lens groups formed on their two side faces is disclosed in United States Patent Application Publication No. 2006/0109443A1, for example, as an optical integrator capable of keeping down influence on the illuminance distribution from manufacturing errors in the large number of microscopic refracting surfaces integrally formed by etching.

### SUMMARY

An embodiment of the present invention provides an optical integrator system capable of ensuring a required large exit-side numerical aperture and forming a desired illuminance distribution on a surface to be illuminated, without need for excessively high accuracy for the surface shape of the optical surfaces of the wavefront dividing elements.

Another embodiment of the present invention provides an illumination optical apparatus capable of illuminating a surface to be illuminated under a desired illumination condition, using the optical integrator system for ensuring the required large exit-side numerical aperture and forming the desired illuminance distribution on the surface to be illuminated.

Still another embodiments of the present invention provide an exposure apparatus and a device manufacturing method capable of performing good exposure under a good illumination condition, using the illumination optical apparatus for illuminating the surface to be illuminated under the desired illumination condition.

For purposes of summarizing the invention, certain aspects, advantages, and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessary achieving other advantages as may be taught or suggested herein.

A first embodiment of the present invention provides an optical integrator system comprising: a first optical integrator having a plurality of first wavefront dividing elements arranged in juxtaposition along a predetermined direction; and a second optical integrator having a plurality of second wavefront dividing elements arranged in juxtaposition along the predetermined direction, the first optical integrator and the second optical integrator being arranged in order from an entrance side of light;

wherein each of the first wavefront dividing elements is so constructed that rays obliquely incident to a center on an optical axis of an entrance surface of the first wavefront dividing element are emitted in parallel with the optical axis from the first wavefront dividing element, and

wherein each of the second wavefront dividing elements is so constructed that rays obliquely incident to a center on an optical axis of an entrance surface of the second wavefront dividing element are emitted obliquely to the optical axis from the second wavefront dividing element.

A second embodiment of the present invention provides an illumination optical apparatus for illuminating a surface to be illuminated by light from a light source, the illumination optical apparatus comprising the optical integrator system of the first embodiment arranged in an optical path between the light source and the surface to be illuminated.

A third embodiment of the present invention provides an exposure apparatus comprising the illumination optical apparatus of the second embodiment for illuminating a predetermined pattern, whereby a photosensitive substrate is exposed with the predetermined pattern.

A fourth embodiment of the present invention provides a device manufacturing method comprising exposing the photosensitive substrate with the predetermined pattern, using the exposure apparatus as set forth in claim 16; and developing the exposed photosensitive substrate.

The optical integrator system according to the first embodiment of the present invention realizes a large divergence angle characteristic required in the predetermined direction, by combination of the first optical integrator with the second optical integrator. In other words, the large exit NA required in the predetermined direction is achieved by cooperation of the first optical integrator and the second optical integrator. Therefore, the present invention allows the maximum exit angle of outgoing light (angle corresponding to the exit NA) required of the wavefront dividing elements of the first optical integrator and the maximum exit angle of outgoing light (angle corresponding to the exit NA) required of the wavefront dividing elements of the second optical integrator to be defined, for example, as half of the maximum exit angle of outgoing light required of a single wavefront dividing element in the conventional technology.

As a result, the optical integrator system according to the first embodiment of the present invention is able to form a desired illuminance distribution on the surface to be illuminated while ensuring the required large exit numerical aperture, without need for excessively high accuracy for the surface shape of optical surfaces of the wavefront dividing elements. Therefore, the illumination optical apparatus according to the second embodiment of the present invention is able to illuminate the surface to be illuminated under a desired illumination condition, using the optical integrator system for ensuring the required large exit numerical aperture and forming the desired illuminance distribution on the surface to be illuminated. The exposure apparatus according to the third embodiment of the present invention is able to perform good exposure under a good illumination condition and, in turn, to manufacture good devices, using the illumination optical apparatus for illuminating the surface to be illuminated under the desired illumination condition.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a drawing schematically showing a configuration of a wavefront dividing element of a cylindrical micro fly's eye lens;

FIG. 2A is a drawing schematically showing a configuration of the exit surface of the first or second fly's eye member;

FIG. 2B is a drawing schematically showing a configuration of the entrance surface of the first fly's eye member;

FIG. 2C is a drawing to illustrate the action of the cylindrical micro fly's eye lens;

FIG. 3A is a drawing to illustrate a configuration of an optical integrator system according to the first aspect of the present invention;

FIG. 3B is a drawing to illustrate a configuration of an optical integrator system according to the first aspect of the present invention;

FIG. 3C is a drawing to illustrate an action of an optical integrator system according to the first aspect of the present invention;

FIG. 4 is a drawing to illustrate a state in which a fly's eye element ensures the same exit NA for obliquely incident parallel light as that for normally incident parallel light;

FIG. 5 is a drawing to illustrate a condition for ensuring the same exit NA for obliquely incident parallel light and normally incident parallel light in a fly's eye element;

FIG. 6 is a drawing to illustrate that light from one wavefront dividing exit surface of a z-directional fly's eye element illuminates at least the whole of one wavefront dividing entrance surface of a prism array;

FIG. 7 is a drawing to illustrate a minimum spacing between the z-directional fly's eye element and the prism array;

FIG. 8 is a drawing to illustrate a maximum spacing between the z-directional fly's eye element and the prism array;

FIG. 9A is a drawing to illustrate a schematic configuration of an optical integrator system according to the second aspect of the present invention;

FIG. 9B is a drawing to illustrate a schematic action of an optical integrator system according to the second aspect of the present invention;

FIG. 10A is a drawing showing an example of optical elements which can be used in place of the prism array in FIG. 3A or 3B;

FIG. 10B is a drawing showing an example of optical elements which can be used in place of the prism array in FIG. 3A or 3B;

FIG. 11 is a drawing schematically showing a configuration of an exposure apparatus according to an embodiment of the present invention;

FIG. 12 is a perspective view schematically showing a configuration of a cylindrical micro fly's eye lens shown in FIG. 11;

FIG. 13 is a drawing schematically showing a configuration of a polarization converting element shown in FIG. 11;

FIG. 14 is a drawing to illustrate the optical activity of rock crystal;

FIG. 15 is a drawing schematically showing a secondary light source of an annular shape set in a circumferentially polarized state by action of the polarization converting element;

FIG. 16 is a drawing schematically showing secondary light sources of quadrupolar shape set in a circumferentially polarized state by action of the polarization converting element;

FIG. 17 is a flowchart of a method for obtaining semiconductor devices as microdevices; and

FIG. 18 is a flowchart of a method for obtaining a liquid-crystal display device as a microdevice;

### DESCRIPTION

Embodiments of the present invention propose a novel design configuration to form a real illumination field (illumination region) with a desired illuminance distribution on a surface to be illuminated by arrangement of a plurality of optical integrators without direct correlation and convolution of light intensity distributions virtually formed on the surface to be illuminated by the respective optical integrators. The arrangement of the plurality of optical integrators without direct correlation herein means that they do not constitute one optical system in which wavefront dividing elements of one optical integrator and wavefront dividing elements of the other optical integrator cooperate to function.

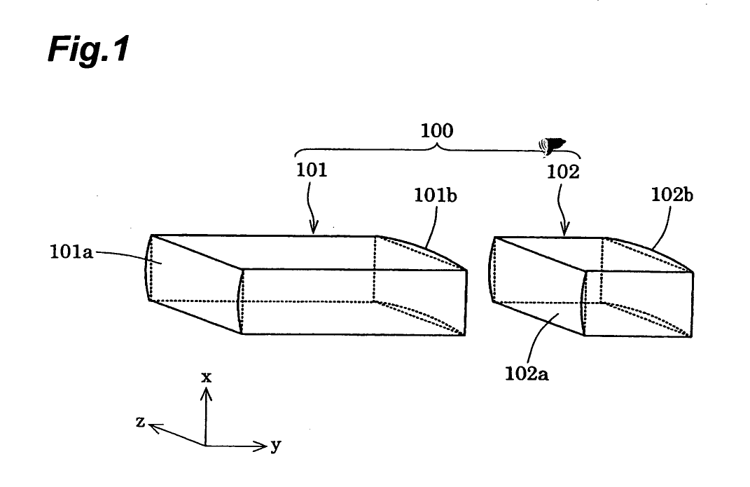

The fundamental configuration and action of the optical integrator system according to an embodiment of the present invention will be described below prior to specific description of embodiments of the present invention. FIG. 1 is a drawing schematically showing the configuration of a wavefront dividing element in the cylindrical micro fly's eye lens, for example, disclosed in United States Patent Application Publication No. 2006/0109443A1. Referring to FIG. 1, a front wavefront dividing element 101 arranged on the entrance side of light has an entrance refracting surface 101a of a cylindrical shape having a refracting power in the x-direction but having no refracting power in the z-direction, and an exit refracting surface 101b of a cylindrical shape having a refracting power in the z-direction but having no refracting power in the x-direction. A rear wavefront dividing element 102 also has an entrance refracting surface 102a of a cylindrical shape having a refracting power in the x-direction but having no refracting power in the z-direction, and an exit refracting surface 102b of a cylindrical shape having a refracting power in the z-direction but having no refracting power in the x-direction.

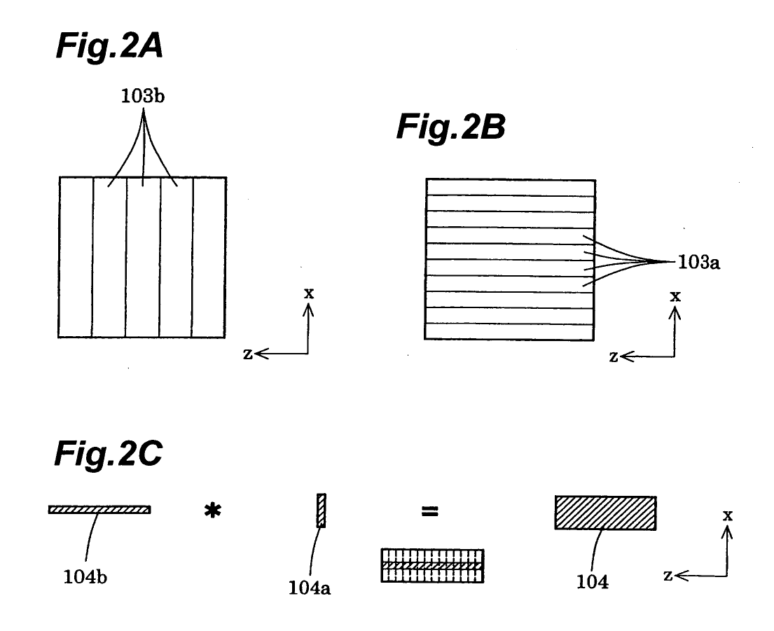

The front wavefront dividing element 101 and the rear wavefront dividing element 102 cooperate to function as a wavefront dividing element of the cylindrical micro fly's eye lens, i.e., as a wavefront dividing element 100 with a rectangular cross section having longer sides in the z-direction and shorter sides in the x-direction. The conventional cylindrical micro fly's eye lens is composed of a first fly's eye member arranged on the front side and a second fly's eye member arranged on the rear side. A plurality of optical surfaces 103b of a cylindrical shape elongated along the x-direction are arrayed in juxtaposition along the z-direction, as shown in FIG. 2A, in the exit surface of the first fly's eye member and in the exit surface of the second fly's eye member.

A plurality of optical surfaces 103a of a cylindrical shape elongated along the z-direction are arrayed in juxtaposition along the x-direction, as shown in FIG. 2B, in the entrance surface of the first fly's eye member and in the entrance surface of the second fly's eye member. In this case, the optical surfaces 103b of the cylindrical shape elongated along the x-direction form on a surface to be illuminated a thin linear illumination region (illumination field) 104b elongated in the z-direction, as shown in FIG. 2C. The optical surfaces 103a of the cylindrical shape elongated along the z-direction form on the surface to be illuminated a thin linear illumination region 104a elongated in the x-direction. It can be interpreted in reality that a desired rectangular illumination field 104 elongated along the z-direction is formed on the surface to be illuminated by two-dimensional convolution of the two fine linear regions 104a and 104b perpendicular to each other, through cooperation of the optical surfaces 103a and 103b of cylindrical shape.

This interpretation is nothing but simple application of the mathematical convolution theorem to optics. The reason is that a relation about amplitudes of light between a surface immediately after the cylindrical micro fly's eye lens and the surface to be illuminated is a mathematical relation of Fourier transform. Namely, the effect of being subjected to the x-directional refracting action and the z-directional refracting action of the cylindrical micro fly's eye lens is equivalent to the effect of multiplication of complex amplitudes and a Fourier transform of complex amplitudes on the surface immediately after the cylindrical micro fly's eye lens results in complex amplitudes on the surface to be illuminated. Therefore, when this mathematical action is considered, the same complex amplitude distribution is obtained by first performing a Fourier transform of two complex amplitude components separately subjected to the x-directional refracting action and to the z-directional refracting action and thereafter implementing the convolution of two complex amplitude components after the Fourier transform, instead of the multiplication of complex amplitudes before the Fourier transform.

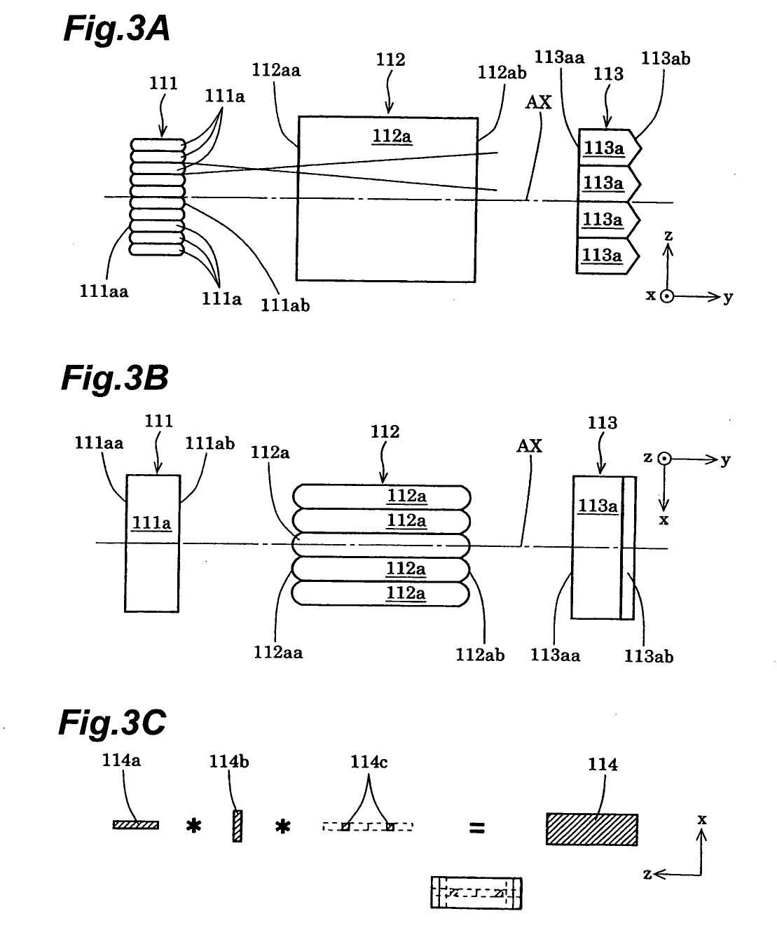

FIGS. 3A to 3C is a drawing to illustrate a schematic configuration and action of an optical integrator system according to the first aspect of the present invention. The optical integrator system of the first aspect is comprised, as shown in FIGS. 3A and 3B, of a z-directional fly's eye element (first optical member of the first optical integrator) 111 having a plurality of wavefront dividing elements 111a arranged in juxtaposition along the z-direction, an x-directional fly's eye element (second optical member of the first optical integrator) 112 having a plurality of wavefront dividing elements 112a arranged in juxtaposition along the x-direction, and a prism array (second optical integrator) 113 having a plurality of wavefront dividing elements 113a arranged in juxtaposition along the z-direction, which are arranged in order from the entrance side of light. A Space between the first and second optical member is filled with a gas, and a space between the second optical member and the second optical integrator is filled with a gas.

Specifically, the z-directional fly's eye element 111 as the first optical member of the first optical integrator has a plurality of entrance refracting surfaces 111aa of a cylindrical shape arranged in juxtaposition in the z-direction, and a plurality of exit refracting surfaces 111ab of a cylindrical shape arranged in juxtaposition in the z-direction. The x-directional fly's eye element 112 as the second optical member of the first optical integrator has a plurality of entrance refracting surfaces 112aa of a cylindrical shape arranged in juxtaposition in the x-direction, and a plurality of exit refracting surfaces 112ab of a cylindrical shape arranged in juxtaposition in the x-direction. The prism array (or a micro prism array) 113 as the second optical integrator has a plurality of entrance refracting surfaces 113aa of a planar shape arranged in juxtaposition in the z-direction, and a plurality of exit refracting surfaces 113ab of a mountain shape arranged in juxtaposition in the z-direction.

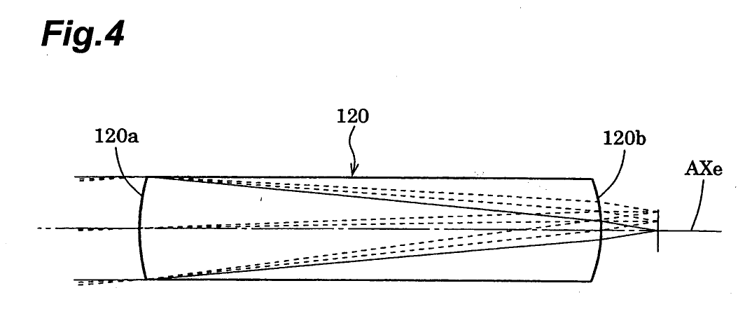

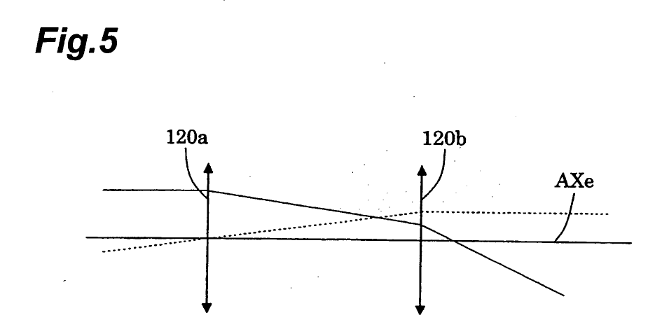

The following will confirmingly describe the fundamental configuration and action of the fly's eye element (which is a broad concept including the fly's eye lens, the micro fly's eye lens, the cylindrical micro fly's eye lens, and so on), with reference to FIGS. 4 and 5. The fly's eye element arranged along the optical axis AX of the illumination optical apparatus functions to uniform the illuminance distribution in the illumination field while ensuring the required illumination field on the surface to be illuminated. For this purpose, beams incident to an entrance surface of each wavefront dividing element form point light sources near an exit surface and then they travel through a condenser optical system to illuminate the illumination region on the surface to be illuminated in a superposed manner. At this time, as shown in FIG. 4, parallel light (as indicated by solid lines in FIG. 4) normally incident to the entrance surface 120a of the wavefront dividing element 120 (or incident along the direction of the optical axis AXe of the wavefront dividing element 120) is emitted as light with a predetermined exit NA (numerical aperture or angular range) from the exit surface 120b and eventually becomes light with the required NA to reach the illumination region.

Parallel light (indicated by dashed lines in FIG. 4) obliquely incident to the entrance surface 120a of the wavefront dividing element 120 (or incident in oblique directions to the optical axis AXe of the element) is also emitted as light with the same exit NA as that of the normally incident parallel light and with its center angle (principal ray angle in each lens element) parallel to the optical axis from the exit surface 120b to reach the illumination region. The condition for ensuring the same exit NA and its center angle of the obliquely incident parallel light as those of the normally incident parallel light is realized by satisfying the condition that a principal ray (indicated by a dashed line in FIG. 5) passing the center on the optical axis (an intersecting point between the entrance surface 120a and the optical axis AXe of the element) on the entrance surface 120a is emitted as light parallel to the optical axis AXe from the exit surface 120b, as shown in FIG. 5. In passing, this condition results in keeping the entrance surface 120a conjugate with the surface to be illuminated.

As described above, the z-directional fly's eye element 111 is so constructed that rays obliquely incident to the center on the optical axis of the entrance surface 111aa of each cylindrical lens element 111a as a wavefront dividing element (the center being defined as an intersecting point between the element optical axis of the lens element 111a and the entrance surface 111aa) are emitted in parallel with the element optical axis. Similarly, the x-directional fly's eye element 112 is also so constructed that rays obliquely incident to the center on the optical axis of the entrance surface 112aa of each cylindrical lens element 112a as a wavefront dividing element (the center being defined as an intersecting point between the element optical axis of the lens element 112a and the entrance surface 112aa) are emitted in parallel with the element optical axis. In contrast to it, the prism array 113 is so constructed that rays obliquely incident to the center on the optical axis of the entrance surface 113aa of each prism element 113a as a wavefront dividing element (the center being defined as an intersecting point between the element optical axis of the prism element 113a and the entrance surface 113aa) are emitted obliquely to the element optical axis.

Therefore, the z-directional fly's eye element 111 is so constructed that a maximum exit angle (half angle; angle corresponding to the exit NA) of outgoing light made by light (parallel light or the like) incident from the direction of the optical axis to the entrance surface 111aa of each cylindrical element 111a as a wavefront dividing element becomes equal to a maximum exit angle (half angle; angle corresponding to the exit NA) of outgoing light made by light (parallel light or the like) incident from oblique directions to the optical axis of the entrance surface 111aa. For this reason, parallel light beams incident at various angles to the z-directional fly's eye element 111 are emitted as light beams with the same NA and center angle parallel to the optical axis and have an exit angle characteristic completely independent of the angular range (NA) and the center angle of incident light to the z-directional fly's eye element 111.

Similarly, the x-directional fly's eye element 112 is so constructed that a maximum exit angle (half angle) of outgoing light made by light (parallel light or the like) incident from the direction of the optical axis to the entrance surface 112aa of each cylindrical lens element 112a as a wavefront dividing element becomes equal to a maximum exit angle (half angle) of outgoing light made by light (parallel light or the like) incident from oblique directions to the optical axis to the entrance surface 112aa. For this reason, parallel light beams incident at various angles to the x-directional fly's eye element 112 are emitted as light beams with the same NA and the center angle parallel to the optical axis, and have an exit angle characteristic completely independent of the angular range (NA) and the center angle of incident light to the x-directional fly's eye element 112. In contrast to it, parallel light beams incident at various angles to the prism array 113 are emitted as light beams with the same NA (angular range) but with their center angle (principal ray angle) being maintained, and result in having an exit angle characteristic dependent on the angular range (NA) and the center angle of incident light to the prism array 113, different from the z-directional fly's eye element 111 and the x-directional fly's eye element 112.

In the optical integrator system of the first aspect, a parallel beam incident to the z-directional fly's eye element 111 forms a thin linear light intensity distribution 114a (cf. FIG. 3C) elongated in the z-direction in the far field, and eventually forms a thin linear illumination region 114a elongated in the z-direction on the surface to be illuminated. A parallel beam incident to the x-directional fly's eye element 112 forms a thin linear light intensity distribution 114b elongated in the x-direction in the far field, and eventually forms a thin linear illumination region 114b elongated in the x-direction on the surface to be illuminated.

A parallel beam incident to the prism array 113 forms two dotlike light intensity distributions 114c spaced in the z-direction in the far field, and eventually forms two dotlike illumination regions 114c spaced in the z-direction on the surface to be illuminated. Actually, a desired rectangular illumination region 114 elongated along the z-direction is formed on the surface to be illuminated by two-dimensional convolution of the thin linear region 114a, the thin linear region 114b, and the two dotlike regions 114c.

In an exposure apparatus of the step-and-scan method, as described below, a shot area of a wafer is scanned and exposed with a mask pattern, while moving a mask and the wafer (photosensitive substrate) in a scanning direction relative to a projection optical system. In this case, the projection optical system is required to have a large image-side numerical aperture, particularly, in a perpendicular direction to scanning (a direction perpendicular to the scanning direction) and, in turn, the wavefront dividing elements of the optical integrator system are required to have a large exit NA in the direction corresponding to the perpendicular direction to scanning.

Specifically, in the case of the cylindrical micro fly's eye lens shown in FIGS. 2A and 2B, since the direction corresponding to the perpendicular direction to scanning is the z-direction, the wavefront dividing elements are required to have the large exit NA in the z-direction and the optical surfaces 103b of the cylindrical shape elongated along the x-direction are eventually required to have the large exit NA. That the optical surfaces 103b of cylindrical shape are required to have the large exit NA means that the thin linear illumination region 104b formed on the surface to be illuminated becomes long along the z-direction. When one attempts to achieve a large exit NA while keeping the z-directional pitch of the optical surfaces 103b of cylindrical shape (or the sectional size of the wavefront dividing elements) small, the radius of curvature of the optical surfaces 103b will become too small to achieve the required surface shape accuracy. As a result, the desired illuminance distribution will not be obtained on the surface to be illuminated and, in turn, it will become difficult to achieve the desired imaging performance during exposure.

In the optical integrator system of the first aspect, as apparent with reference to FIG. 3C showing the light intensity distribution components undergoing convolution, in a resolved state, the high divergence angle characteristic required in the z-direction corresponding to the perpendicular direction to scanning is realized by combination of the z-directional fly's eye element 111 with the prism array 113. In other words, the large exit NA required in the z-direction corresponding to the perpendicular direction to scanning is achieved by cooperation of the z-directional fly's eye element 111 and the prism array 113 exercising the refracting action only in the z-direction.

Therefore, when the description is simplified by considering the burden on the z-directional fly's eye element 111 and the burden on the prism array 113 as equal to each other, the maximum exit angle of outgoing light required of the wavefront dividing elements of the z-directional fly's eye element 111 and the maximum exit angle of outgoing light required of the wavefront dividing elements of the prism array 113 can be, for example, half of the maximum exit angle of outgoing light required of a single wavefront dividing element in the conventional technology. The x-directional fly's eye element 112, different from the z-directional fly's eye element 111 and the prism array 113 exercising the refracting action only in the z-direction, is just an ordinary fly's eye element exercising the refracting action only in the x-direction for achieving a relatively small exit NA in the x-direction corresponding to the scanning direction.

In the optical integrator system of the first aspect, the two elements 111 and 113 exercising the refracting action only in the z-direction corresponding to the perpendicular direction to scanning can be located as described below. Namely, the prism array 113, which is so constructed that rays obliquely incident to the center on the optical axis of the entrance surface of each wavefront dividing element are emitted obliquely to the element optical axis, can be located downstream of the z-directional fly's eye element 111, which is so constructed that rays obliquely incident to the center on the optical axis of the entrance surface of each wavefront dividing element are emitted in parallel with the element optical axis.

The prism array 113, different from the z-directional fly's eye element 111, acts with oblique incidence of parallel light to maintain the angle of inclination dependent on the oblique incidence while forming a predetermined divergence angle distribution, and results in exercising an effect of shifting the position of the illumination region on the surface to be illuminated. In other words, when the prism array 113 is replaced with a fly's eye element C acting to convert obliquely incident parallel light into parallel light along the optical-axis direction, it will result in forming on the surface to be illuminated a light intensity distribution by only the fly's eye element C completely independent of the divergence angle distribution of light emitted from the z-directional fly's eye element 111 and failing to achieve the convolution effect of the z-directional fly's eye element 111 and the fly's eye element C.

For example movement of a movable optical member arranged upstream of the z-directional fly's eye element 111 causes a change in angles of light incident to the wavefront dividing elements (lens elements) 111a (or angles to the element optical axis made by centroid rays or center rays of incident beams) or in an angular range (maximum angle made by rays incident to one point on the entrance surface 111aa). However, since the z-directional fly's eye element 11 is located upstream of the prism array 113, the action of this z-directional fly's eye element 111 stabilizes the angles and angular range of light incident to each wavefront dividing element (prism element) 113a of the prism array 113 and light always passes through the same region on the exit surface 113ab of each wavefront dividing element of the prism array 113. As a result, for example, even when the upstream movable optical member moves to change the angles and angular range of light incident to the z-directional fly's eye element 111, the illumination region is stably formed without variation on the surface to be illuminated and the illuminance distribution is also stabilized without occurrence of illuminance unevenness in the illumination region on the surface to be illuminated.

In the optical integrator system according to the first aspect of the present invention, as described above, the high divergence angle characteristic required in the z-direction corresponding to the perpendicular direction to scanning, and, therefore, the large exit NA required in the z-direction are achieved by cooperation of the z-directional fly's eye element 111 and the prism array 113 exercising the refracting action only in the z-direction. Therefore, the maximum exit angle required of the wavefront dividing elements 111a of the z-directional fly's eye element 111 (angle corresponding to the exit NA) and the maximum exit angle required of the wavefront dividing elements 113a of the prism array 113 (angle corresponding to the exit NA) can be, for example, just half of the maximum exit angle required of a single wavefront dividing element in the conventional technology.

This means that, for example, the radius of curvature of the optical surfaces 111aa, 111ab in the wavefront dividing elements 111a of the z-directional fly's eye element 111 does not have to be designed too small. Therefore, the optical integrator system according to the first aspect is able to ensure the required large exit numerical aperture and form the desired illuminance distribution on the surface to be illuminated, without need for excessively high accuracy for the surface shape of the optical surfaces 111aa, 111ab in the wavefront dividing elements 111a of the z-directional fly's eye element 111.

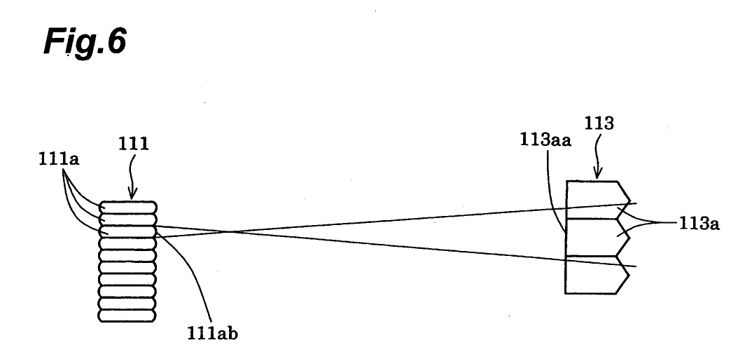

In order to suitably achieve the effect of the first aspect by adequately exercising the action of the z-directional fly's eye element 111 in the optical integrator system according to the first aspect, however, it is important, as shown in FIG. 6, that the light emitted from the exit surface 111ab of one wavefront dividing element 111a of the z-directional fly's eye element 111 may illuminate at least the entire entrance surface 113aa of one wavefront dividing element 113a of the prism array 113. When the system is so constructed that the light from the exit surface 111ab illuminates only a portion of the entrance surface 113aa, the angles and angular range of incident light will not be kept constant across the entire entrance surface 113aa, so as to result in failure in maintaining a uniform illuminance distribution on the surface to be illuminated.

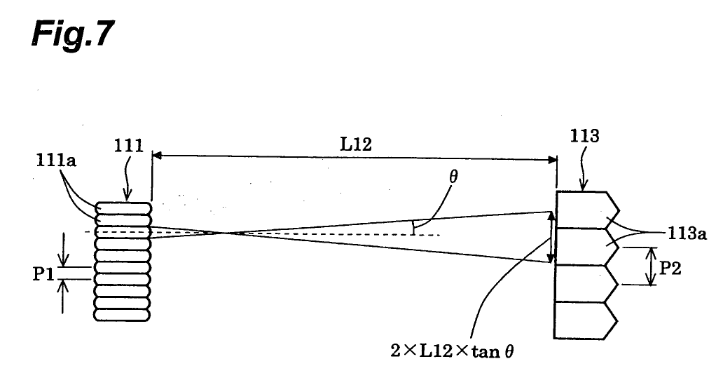

In other words, the optical integrator system according to the first aspect is so constructed that the spacing L12 between the exit surface of the z-directional fly's eye element (first optical member of the first optical integrator) 111 and the entrance surface of the prism array (second optical integrator) 113 satisfies the following Condition (1), as shown in FIG. 7. In Condition (1), P2 is the pitch of the wavefront dividing elements 113a of the prism array 113 and θ the maximum exit angle (half angle) of light from the wavefront dividing element 111a of the z-directional fly's eye element 111.

P2/(2×tan θ)<L12 (1)

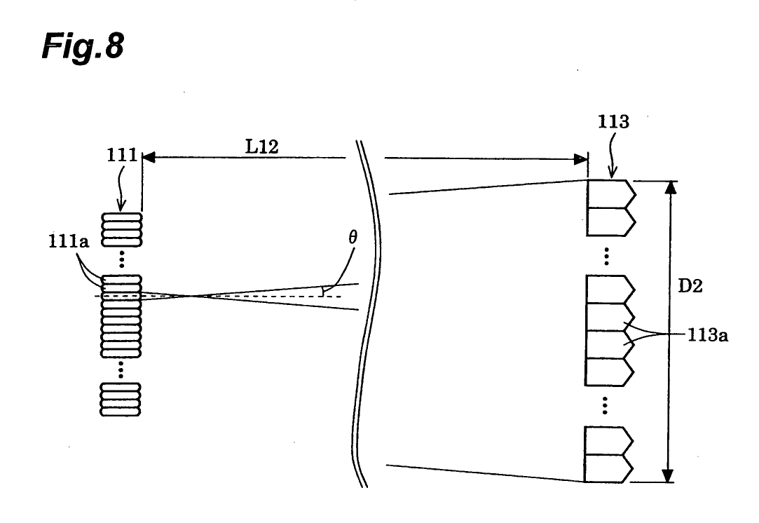

Condition (1) demands that the spacing L12 between the exit surface of the z-directional fly's eye element 111 and the entrance surface of the prism array 113 should be set larger than a predetermined value. However, to set the spacing L12 too large may cause a loss in light quantity because portion of light from one exit refracting surface 111ab of the z-directional fly's eye element 111 becomes not incident to the prism array 113 (or not to contribute to illumination). Namely, from the viewpoint of avoiding the loss in light quantity, the spacing L12 is allowed to satisfy the following Condition (2) as shown in FIG. 8. In Condition (2), D2 is a length of the entrance surface of the prism array 113.

L2/<D2/(2×tan θ) (2)

While the pitch P1 (cf. FIG. 7) of the wavefront dividing elements 111a of the z-directional fly's eye element 111 is set as small as possible, the pitch P2 of the wavefront dividing elements 113a of the prism array 113 can be set so as to be substantially different from an integral multiple of the pitch P1. When the pitch P2 of the wavefront dividing elements 113a is set to an integral multiple of the pitch P1 of the wavefront dividing elements 111a, periodical overlap structures will become likely to appear in the illuminance distribution of light incident to one wavefront dividing element 113a of the prism array 113, so that a uniform illuminance distribution cannot be obtained on the surface to be illuminated.

There is no need for highly accurately positioning the z-directional fly's eye element (first optical member of the first optical integrator) 111 and the prism array (second optical integrator) 113 in the z-direction (vertical direction in FIGS. 7 and 8) corresponding to the perpendicular direction to scanning. The light emitted from the exit surface 111ab of one wavefront dividing element 111a of the z-directional fly's eye element 111 can illuminate at least the entire entrance surface 113aa of one wavefront dividing element 113a of the prism array 113, thereby to keep constant the angles and angular range of light incident to the entrance surface 113aa.

In the configuration shown in FIGS. 3A and 3B, the x-directional fly's eye element 112 is arranged in the optical path between the z-directional fly's eye element 111 and the prism array 113. However, the arrangement does not have to be limited to this, and a variety of modification examples can be contemplated for the arrangement of the x-directional fly's eye element 112. Specifically, the x-directional fly's eye element 112 may be located upstream of the z-directional fly's eye element 111 or the x-directional fly's eye element 112 may be located downstream of the prism array 113. In the first aspect, the prism array 113 can be located downstream of the z-directional fly's eye element 111. It is, however, noted that a compact optical integrator system can be realized by locating the x-directional fly's eye element 112 in the optical path between the z-directional fly's eye element 111 and the prism array 113 to be spaced by a predetermined distance from each other.

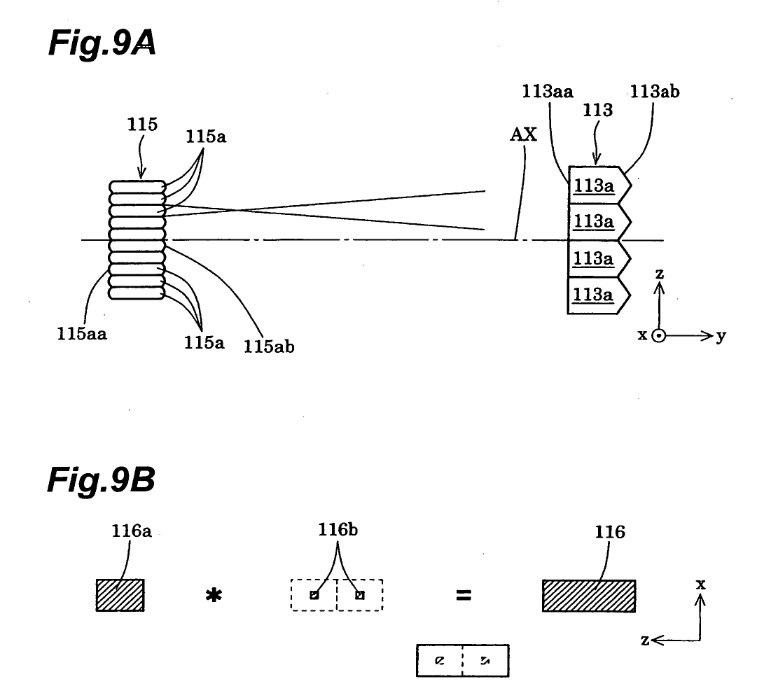

FIGS. 9A and 9B is a drawing to illustrate a schematic configuration and action of an optical integrator system according to the second aspect of the present invention. The second aspect of FIGS. 9A and 9B has the configuration similar to the first aspect of FIGS. 3A and 3B but is basically different from the first aspect of FIGS. 3A and 3B in that the z-directional fly's eye element 111 and the x-directional fly's eye element 112 are replaced by a bidirectional fly's eye element 115. Namely, the optical integrator system according to the second aspect is comprised of a bidirectional fly's eye element (first optical integrator) 115 having a plurality of wavefront dividing elements 115a two-dimensionally juxtaposed in two directions of the z-direction and the x-direction, and a prism array (second optical integrator) 113 having a plurality of wavefront dividing elements 113a arranged in juxtaposition along the z-direction, which are arranged in order from the entrance side of light, as shown in FIG. 9A.

Specifically, the bidirectional fly's eye element 115 has a plurality of entrance refracting surfaces 115aa of a quadric shape arranged vertically and horizontally and densely, and a plurality of exit refracting surfaces 115ab of a quadric shape arranged vertically and horizontally and densely. In other words, the bidirectional fly's eye element 115 is, for example, a fly's eye lens consisting of a plurality of biconvex lens elements 115a arranged vertically and horizontally and densely, and is so constructed that rays obliquely incident to the center on the optical axis of the entrance surface 115aa of each wavefront dividing element 115a are emitted in parallel with the element optic axis.

The bidirectional fly's eye element 115 is so constructed that the maximum exit angle (half angle; angle corresponding to the exit NA) of outgoing light made by light incident from the direction of the optical axis to the entrance surface 115aa of each wavefront dividing element 115a becomes equal to the maximum exit angle (half angle; angle corresponding to the exit NA) of outgoing light made by light incident from oblique directions to the optical axis to the entrance surface 115aa. In the optical integrator system of the second aspect, a parallel beam incident to the bidirectional fly's eye element 115 forms a rectangular light intensity distribution 116a (cf. FIG. 9B) elongated in the z-direction in the far field, and eventually forms a rectangular illumination region 116a elongated in the z-direction on the surface to be illuminated.

A parallel beam incident to the prism array 113 forms two dotlike light intensity distributions 116b spaced in the z-direction in the far field and eventually forms two dotlike illumination regions 116b spaced in the z-direction on the surface to be illuminated, as described previously. Actually, a desired rectangular illumination region 116 elongated along the z-direction is formed on the surface to be illuminated by two-dimensional convolution of the rectangular region 116a and the two dotlike regions 116b.

In the optical integrator system according to the second aspect, the high divergence angle characteristic required in the z-direction corresponding to the perpendicular direction to scanning and, therefore, the large exit NA required in the z-direction are realized by combination (cooperation) of the bidirectional fly's eye element 115 and the prism array 113. Therefore, the optical integrator system is able to ensure the required large exit numerical aperture and to form the desired illuminance distribution on the surface to be illuminated, for example, without need for excessively high accuracy for the surface shape of the optical surfaces 115aa, 115ab in the wavefront dividing elements 115a of the bidirectional fly's eye element 115.

In the second aspect of the present invention, the prism array 113 can be located downstream of the bidirectional fly's eye element 115. In addition, the spacing L12 between the exit surface of the bidirectional fly's eye element 115 and the entrance surface of the prism array 113 can satisfy the aforementioned Conditions (1) and (2). The pitch P2 of the wavefront dividing elements 113a of the prism array 113 can be set so as to be substantially different from an integral multiple of the pitch P1, while setting the z-directional pitch P1 of the wavefront dividing elements 115a of the bidirectional fly's eye element 115 as small as possible. It is also the case in the second aspect that there is no need for highly accurately positioning the bidirectional fly's eye element 115 and the prism array 113 in the z-direction corresponding to the perpendicular direction to scanning.

The above-described first aspect and second aspect employ the prism array with the plurality of prism elements arranged in juxtaposition along the z-direction, as the second optical integrator. However, the optical integrator system does not have to be limited to this, but a prism array with a plurality of prism elements two-dimensionally juxtaposed (in the z-direction and in the x-direction) can also be used to realize the high divergence angle characteristic in the two directions of the z-direction and the x-direction and, in turn, the large exit NA through cooperation with the first optical integrator and the second optical integrator.

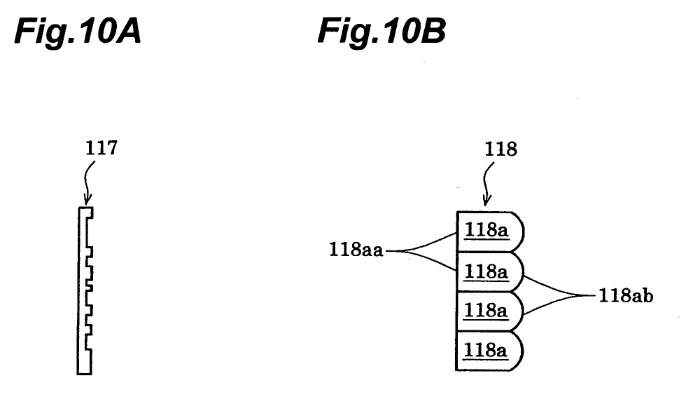

The above-described first aspect and second aspect use the prism array 113 with the plurality of prism elements 113a as the second optical integrator. However, the second optical integrator does not have to be limited to this, but the second optical integrator can also be any other optical element which is so constructed that rays obliquely incident to the center on the optical axis of the entrance surface of each wavefront dividing element are emitted obliquely to the element optical axis from the wavefront dividing element. Specifically, the prism array 113 can be replaced by a diffractive optical element 117 as shown in FIG. 10A. The diffractive optical element 117 is made by forming level differences at the pitch approximately equal to the wavelength of used light in a substrate so as to have a plurality of wavefront dividing elements arranged in juxtaposition along at least one direction, and has an action to diffract an incident beam to desired angles.

The prism array 113 can also be replaced, for example, by a microlens array 118 consisting of a plurality of plano-convex cylindrical lens elements 118a arranged in juxtaposition along at least one direction, as shown in FIG. 10B. The entrance surfaces 118aa of the cylindrical lens elements 118a are planar and the exit surfaces 118ab are cylindrical. When the diffractive optical element 117 is used instead of the prism array 113, the system can achieve the effect similar to that in the aforementioned first aspect and second aspect.

It is, however, noted that when the microlens array 118 is used instead of the prism array 113, it is difficult to obtain an illuminance distribution of a top hat shape along the z-direction corresponding to the perpendicular direction to scanning, on the surface to be illuminated and, in turn, to achieve the effect equivalent to that in the aforementioned first aspect and second aspect. In order to obtain the illuminance distribution of the top hat shape, it is possible, for example, to use an array member consisting of a plurality of wavefront dividing elements having an intermediate form between the prism elements 113a and the cylindrical lens elements 118a, i.e., a plurality of wavefront dividing elements having a planar entrance surface and an exit surface of an aspherical shape, as the second optical integrator.

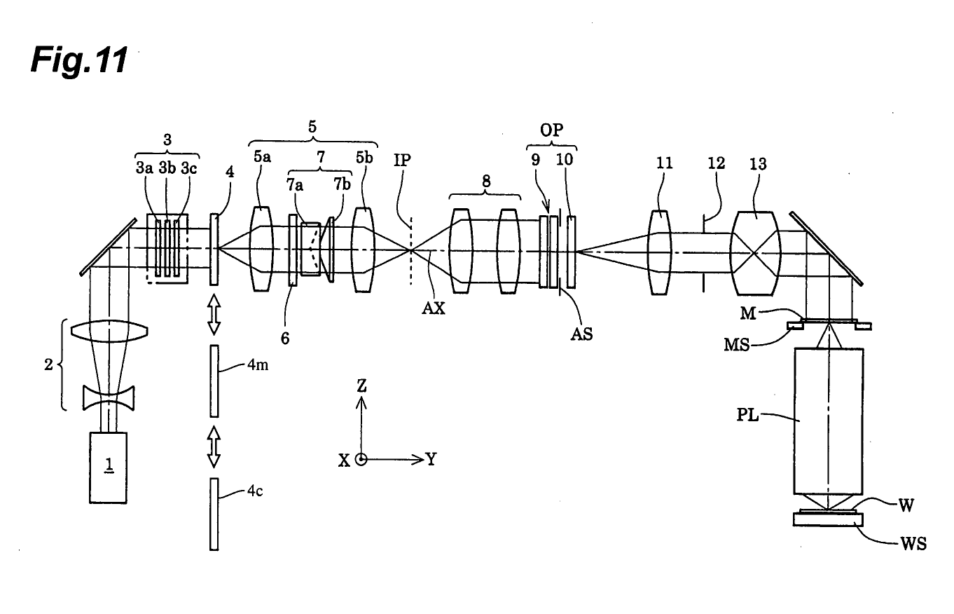

Embodiments of the present invention will be described on the basis of the accompanying drawings. FIG. 11 is a drawing schematically showing a configuration of an exposure apparatus according to an embodiment of the present invention. In FIG. 11, the Z-axis is defined along a direction of a normal to a wafer W being a photosensitive substrate, the Y-axis along a direction parallel to the page of FIG. 11 in the surface of the wafer W, and the X-axis along a direction normal to the page of FIG. 11 in the surface of the wafer W. With reference to FIG. 11, the exposure apparatus of the present embodiment is provided with a light source 1 for supplying exposure light (illumination light). The light source 1 can be, for example, an ArF excimer laser light source for supplying light at the wavelength of 193 nm, a KrF excimer laser light source for supplying light at the wavelength of 248 nm, or the like.

The light emitted from the light source 1 is expanded into a beam of a required sectional shape by a shaping optical system 2 and the expanded beam travels through a polarization state switch 3 and a diffractive optical element 4 for annular illumination to enter an afocal lens 5. The polarization state switch 3 is composed of a quarter wave plate 3a the crystal optical axis of which is arranged to be rotatable about the optical axis AX and which converts elliptically polarized light incident thereto, into linearly polarized light, a half wave plate 3b the crystal optical axis of which is arranged to be rotatable about the optical axis AX and which changes a direction of polarization of incident linearly polarized light, and a depolarizer (depolarizing element) 3c arranged as retractable from the illumination optical path.

In a state in which the depolarizer 3c is retracted from the illumination optical path, the polarization state switch 3 has a function to convert the light from the light source 1 into linearly polarized light having a desired polarization direction and guide the linearly polarized light into the diffractive optical element 4; in a state in which the depolarizer 3c is set in the illumination optical path, the polarization state switch 3 has a function to convert the light from the light source 1 into substantially unpolarized light and guide the unpolarized light into the diffractive optical element 4. The afocal lens 5 is an afocal system (afocal optical system) the front focal position of which agrees substantially with the position of the diffractive optical element 4 and the rear focal position of which agrees substantially with a position of a predetermined plane IP indicated by a dashed line in the drawing.

The diffractive optical element 4 is made by forming level differences at the pitch approximately equal to the wavelength of the exposure light (illumination light) in a substrate, and has the action to diffract an incident beam to desired angles. Specifically, the diffractive optical element 4 for annular illumination has the following function: when a parallel beam with a rectangular cross section is incident thereto, it forms an annular light intensity distribution in its far field (or Fraunhofer diffraction region). Therefore, a nearly parallel beam incident to the diffractive optical element 4 forms an annular light intensity distribution on the pupil plane of the afocal lens 5 and is then emitted in an annular angle distribution from the afocal lens 5.

A polarization converting element 6 and a conical axicon system 7 are arranged in the optical path between a front lens unit 5a and a rear lens unit 5b of the afocal lens 5 and at or near the pupil position thereof. The configurations and actions of the polarization converting element 6 and the conical axicon system 7 will be described later. The beam having passed through the afocal lens 5 travels through a zoom lens 8 for varying the σ value (σ value=mask-side numerical aperture of the illumination optical apparatus/mask-side numerical aperture of the projection optical system), to enter an optical integrator system OP. The optical integrator system OP is composed of a cylindrical micro fly's eye lens 9 as the first optical integrator having a plurality of wavefront dividing elements two-dimensionally juxtaposed, and a prism array (or micro prism array) 10 as the second optical integrator having a plurality of wavefront dividing elements arranged in juxtaposition along the Z-direction, in order from the entrance side of light.

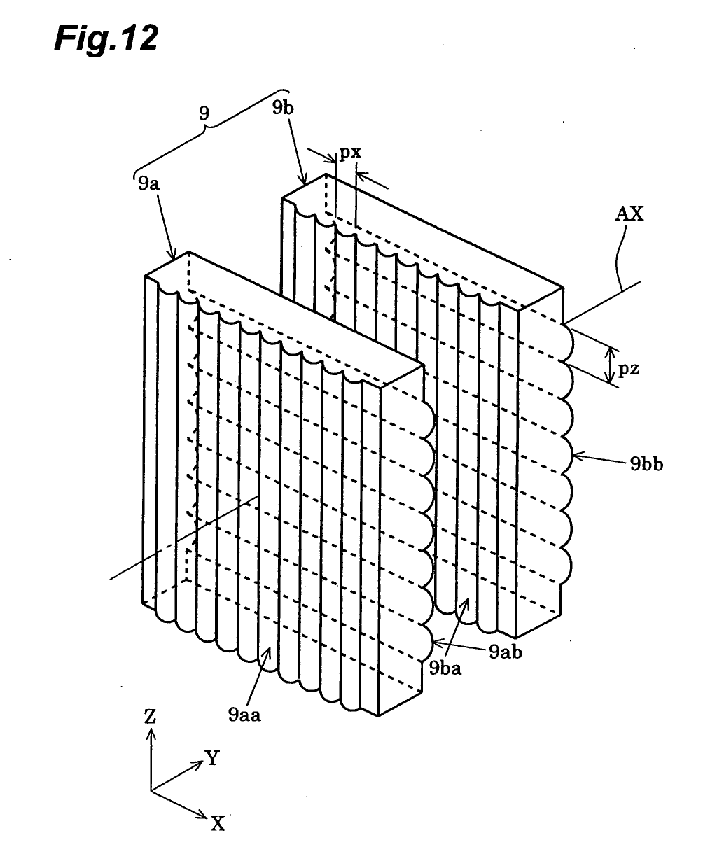

The prism array 10 has a configuration similar to that of the prism array 113 shown in FIGS. 3A, 3B and 9 and is composed of a plurality of prism elements arrayed in the Z-direction. The cylindrical micro fly's eye lens 9 is an optical element having a function similar to that of the bidirectional fly's eye element 115 shown in FIG. 9A and is composed of a first fly's eye member 9a located on the light source side and a second fly's eye member 9b located on the mask side, as shown in FIG. 12. Cylindrical lens groups 9aa and 9ba arrayed in juxtaposition in the X-direction are formed each at the pitch px in the light-source-side surface of the first fly's eye member 9a and in the light-source-side surface of the second fly's eye member 9b, respectively.

Cylindrical lens groups 9ab and 9bb arrayed in juxtaposition in the Z-direction are formed each at the pitch pz (pz>px) in the mask-side surface of the first fly's eye member 9a and in the mask-side surface of the second fly's eye member 9b, respectively. When attention is focused on the refracting action in the X-direction (or the refracting action in the XY plane) of the cylindrical micro fly's eye lens 9, a parallel beam incident along the optical axis AX is wavefront-divided at the pitch px along the X-direction by the cylindrical lens group 9aa formed on the light source side of the first fly's eye member 9a, condensed by the refracting surfaces thereof, and thereafter condensed by the refracting surfaces of the corresponding cylindrical lenses in the cylindrical lens group 9ba formed on the light source side of the second fly's eye member 9b, to be converged on the rear focal plane of the cylindrical micro fly's eye lens 9.

When attention is focused on the refracting action in the Z-direction (or the refracting action in the YZ plane) of the cylindrical micro fly's eye lens 9, a parallel beam incident along the optical axis AX is wavefront-divided at the pitch pz along the Z-direction by the cylindrical lens group 9ab formed on the mask side of the first fly's eye member 9a, condensed by the refracting surfaces thereof, and thereafter condensed by the refracting surfaces of the corresponding cylindrical lenses in the cylindrical lens group 9bb formed on the mask side of the second fly's eye member 9b, to be converged on the rear focal plane of the cylindrical micro fly's eye lens 9.

As described above, the cylindrical micro fly's eye lens 9 is composed of the first fly's eye member 9a and the second fly's eye member 9b in each of which the cylindrical lens groups are arranged in the two side faces, and exercises the same optical function as the micro fly's eye lens in which a large number of rectangular microscopic refracting surfaces (wavefront dividing elements) having the size of px in the X-direction and the size of pz in the Z-direction are integrally formed vertically and horizontally and densely. The cylindrical micro fly's eye lens 9 is able to keep down change in distortion due to variation in the surface shape of the microscopic refracting surfaces and, for example, to reduce the influence on the illuminance distribution from manufacturing errors of the large number of microscopic refracting surfaces integrally formed by etching.

The position of the predetermined plane IP is located near the front focal position of the zoom lens 8 and the entrance surface of the cylindrical micro fly's eye lens 9 is located near the rear focal position of the zoom lens 8. In other words, the zoom lens 8 acts to keep the predetermined plane IP and the entrance surface of the cylindrical micro fly's eye lens 9 substantially in the relation of Fourier transform and, in turn, to keep the pupil plane of the afocal lens 5 and the entrance surface of the cylindrical micro fly's eye lens 9 optically substantially conjugate with each other.

Therefore, for example, an annular illumination field centered on the optical axis AX is formed on the entrance surface of the cylindrical micro fly's eye lens 9 as on the pupil plane of the afocal lens 5. The overall shape of this annular illumination field similarly varies depending upon the focal length of the zoom lens 8. A rectangular microscopic refracting surface as a wavefront dividing unit element in the cylindrical micro fly's eye lens 9 is of a rectangular shape similar to a shape of an illumination field to be formed on a mask M (and, in turn, similar to a shape of an exposure region to be formed on a wafer W).

The beam incident to the cylindrical micro fly's eye lens 9 is two-dimensionally divided to form a secondary light source with a light intensity distribution approximately identical with the illumination field formed by the incident beam, i.e., a secondary light source consisting of a substantial surface illuminant of an annular shape centered on the optical axis AX, on or near the rear focal plane of the cylindrical micro fly's eye lens 9 (and on the illumination pupil virtually). Beams from the secondary light source formed on or near the rear focal plane of the cylindrical micro fly's eye lens 9 is incident to an aperture stop AS located near it.

The aperture stop AS has an aperture (light transmitting portion) of an annular shape corresponding to the secondary light source of the annular shape formed on or near the rear focal plane of the cylindrical micro fly's eye lens 9. The aperture stop AS is arranged as retractable from the illumination optical path and is arranged as replaceable with a plurality of aperture stops having respective apertures of different sizes and shapes. A method of switching the aperture stops can be selected, for example, from the well-know turret method and slide method, and others. The aperture stop AS is located at a position optically approximately conjugate with the entrance pupil plane of the projection optical system PL described later, and defines a range to contribute to illumination of the secondary light source. The installation of the aperture stop AS can be omitted.

The light from the secondary light source limited by the aperture stop AS travels through a prism array 10 and a condenser optical system 11 to illuminate a mask blind 12 in a superimposed manner. In this manner, an illumination field of a rectangular shape according to the shape and focal length of the rectangular microscopic refracting surfaces being the wavefront dividing elements of the cylindrical micro fly's eye lens 9 is formed on the mask blind 12 as an illumination field stop. The light having passed through a rectangular aperture (light transmitting portion) of the mask blind 12 is focused by an imaging optical system 13 and thereafter illuminates the mask M with a predetermined pattern therein, in a superimposed manner. Namely, the imaging optical system 13 forms an image of the rectangular aperture of the mask blind 12 on the mask M.

The pattern to be transferred is formed in the mask M held on a mask stage MS and the mask is illuminated in a pattern region of a rectangular shape (slit shape) having longer sides along the Y-direction and shorter sides along the X-direction in the entire pattern region. The light having passed through the pattern region of the mask M travels through the projection optical system PL to form an image of the mask pattern on the wafer (photosensitive substrate) W held on a wafer stage WS. Namely, the pattern image is formed in a still exposure area (effective exposure area) of a rectangular shape having longer sides along the Y-direction and shorter sides along the X-direction on the wafer W as well, so as to optically correspond to the rectangular illumination region on the mask M.

In this configuration, the mask stage MS and the wafer stage WS and, therefore, the mask M and the wafer W are synchronously moved (scanned) along the X-direction (scanning direction) in the plane (XY plane) perpendicular to the optical axis AX of the projection optical system PL in accordance with the so-called step-and-scan method, whereby a shot area (exposure area) having a width equal to the Y-directional length of the still exposure area and a length according to a scanning distance (moving distance) of the wafer W, is scanned and exposed with the mask pattern on the wafer W.

A diffractive optical element 4m for multi-pole illumination (dipole illumination, quadrupole illumination, octupole illumination, or the like) can be set instead of the diffractive optical element 4 for annular illumination in the illumination optical path, thereby to implement multi-pole illumination. When a parallel beam with a rectangular cross section is incident to the diffractive optical element for multi-pole illumination, the diffractive optical element for multi-pole illumination functions to form light intensity distributions of multi-pole shape (dipole, quadrupole, octupole, or other shape) in its far field. Therefore, beams having passed through the diffractive optical element for multi-pole illumination form illumination fields of multi-pole shape consisting of a plurality of circular illumination fields around the optical axis AX, for example, on the entrance surface of the cylindrical micro fly's eye lens 9. As a result, secondary light sources of the same multi-pole shape as the illumination fields formed on the entrance surface are also formed on or near the rear focal plane of the cylindrical micro fly's eye lens 9.

When a diffractive optical element 4c for circular illumination is set instead of the diffractive optical element 4 for annular illumination in the illumination optical path, it can implement normal circular illumination. When a parallel beam with a rectangular cross section is incident to the diffractive optical element for circular illumination, the diffractive optical element for circular illumination functions to form a light intensity distribution of a circular shape in the far field. Therefore, a beam having passed through the diffractive optical element for circular illumination forms an illumination field of a circular shape centered on the optical axis AX, for example, on the entrance surface of the cylindrical micro fly's eye lens 9. As a result, a secondary light source of the same circular shape as the illumination field formed on the entrance surface is also formed on or near the rear focal plane of the cylindrical micro fly's eye lens 9. When a diffractive optical element with an appropriate characteristic (not shown) is set instead of the diffractive optical element 4 for annular illumination in the illumination optical path, it becomes feasible to implement one of various forms of modified illuminations. A method of switching the diffractive optical element 4 can be selected, for example, from the well-known turret method and slide method, and others.

The conical axicon system 7 is composed of a first prism member 7a with a plane on the light source side and a refracting surface of a hollow conical shape on the mask side, and a second prism member 7b with a plane on the mask side and a refracting surface of a convex conical shape on the light source side, which are arranged in order from the light source side. The hollow conical refracting surface of the first prism member 7a and the convex conical refracting surface of the second prism member 7b are complementarily formed so as to fit each other. At least one of the first prism member 7a and the second prism member 7b is arranged as movable along the optical axis AX so as to be able to vary the spacing between the hollow conical refracting surface of the first prism member 7a and the convex conical refracting surface of the second prism member 7b. The action of the conical axicon system 7 and the action of the zoom lens 8 will be described below with a focus on the annular or quadrupolar secondary light sources.

In a state in which the hollow conical refracting surface of the first prism member 7a and the convex conical refracting surface of the second prism member 7b are in contact with each other, the conical axicon system 7 functions as a plane-parallel plate and causes no effect on the annular or quadrupolar secondary light sources formed. As the hollow conical refracting surface of the first prism member 7a and the convex conical refracting surface of the second prism member 7b are moved away from each other, the outside diameter (inside diameter) of the annular or quadrupolar secondary light sources varies while the width of the annular or quadrupolar secondary light sources (half of the difference between the outside diameter and the inside diameter of the annular secondary light source; or half of the difference between the diameter (outside diameter) of a circle circumscribed about the quadrupolar secondary light sources and the diameter (inside diameter) of a circle inscribed in the quadrupolar secondary light sources) is kept constant. Namely, the separation results in change in the annular ratio (inside diameter/outside diameter) and the size (outside diameter) of the annular or quadrupolar secondary light sources.

The zoom lens 8 has a function to similarly enlarge or reduce the overall shape of the annular or quadrupolar secondary light sources. For example, when the focal length of the zoom lens 8 is increased from a minimum to a predetermined value, the overall shape of the annular or quadrupolar secondary light sources is similarly enlarged. In other words, the action of the zoom lens 8 varies both the width and the size (outside diameter), without change in the annular ratio of the annular or quadrupolar secondary light sources. In this manner, the annular ratio and size (outside diameter) of the annular or quadrupolar secondary light sources can be controlled by the actions of the conical axicon system 7 and the zoom lens 8.

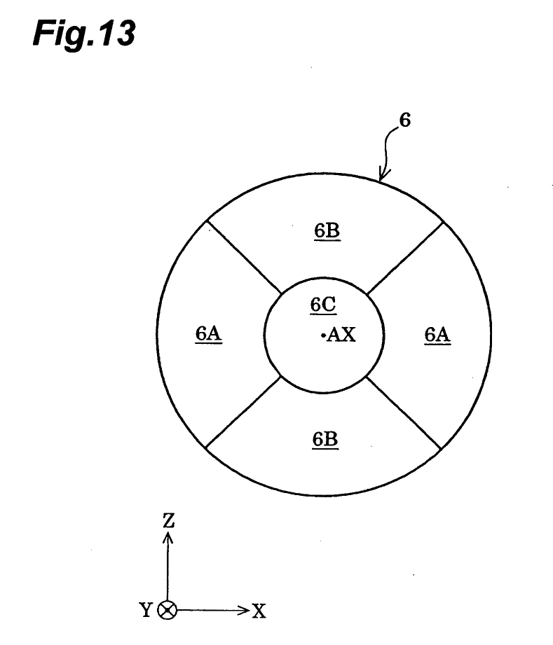

The polarization converting element 6 is arranged at or near the pupil position of the afocal lens 5, i.e., on or near the pupil plane of the illumination optical system (2-13). In the case of the annular illumination, therefore, a beam with an approximately annular cross section centered on the optical axis AX is incident to the polarization converting element 6. The polarization converting element 6, as shown in FIG. 13, has an effective region of an annular shape centered on the optical axis AX as a whole and this annular effective region is composed of four basic elements of a fan shape around the optical axis AX obtained by equally dividing the effective region in the circumferential direction. Among these four basic elements, a pair of basic elements opposed on both sides of the optical axis AX have the same characteristics.

Namely, the four basic elements consist of two types of basic elements 6A and 6B two each with mutually different thicknesses (lengths in the optical-axis direction) along the transmitting direction (Y-direction) of light. Specifically, the thickness of the first basic elements 6A is set larger than the thickness of the second basic elements 6B. As a result, one surface (e.g., the entrance surface) of the polarization converting element 6 is planar, while the other surface (e.g., the exit surface) is uneven because of the difference between the thicknesses of the basic elements 6A, 6B. Each of the basic elements 6A, 6B is made of rock crystal being an optical material with optical activity (rotatory polarization characteristic) and its crystal optical axis is set to be aligned approximately with the optical axis AX.

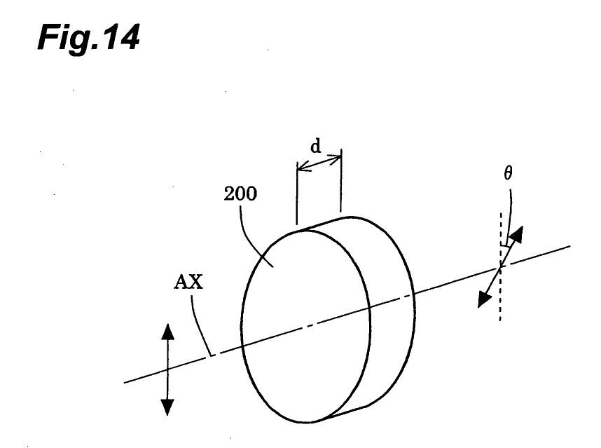

The optical activity of rock crystal will be briefly described below with reference to FIG. 14. Referring to FIG. 14, an optical member 200 of plane-parallel plate shape made of rock crystal in the thickness d is arranged so that its crystal optical axis is aligned with the optical axis AX. In this case, linearly polarized light incident to the optical member 200 is emitted in a state in which its polarization direction is rotated by θ about the optical axis AX by virtue of the optical activity thereof. At this time, the angle of rotation (optical activity angle) θ of the polarization direction due to the optical activity of the optical member 200 is represented by Eq (a) below, using the thickness d of the optical member 200 and the optical activity ρ of rock crystal.

θ=d·p (a)

In general, the optical activity ρ of rock crystal has wavelength dependence (a property of varying values of optical activity dependent on wavelengths of used light: optical activity dispersion) and, specifically, it tends to increase with decrease in the wavelength of used light. According to the description on p 167 in “Applied Optics II,” the optical activity ρ of rock crystal for light with the wavelength of 250.3 nm is 153.9°/mm.

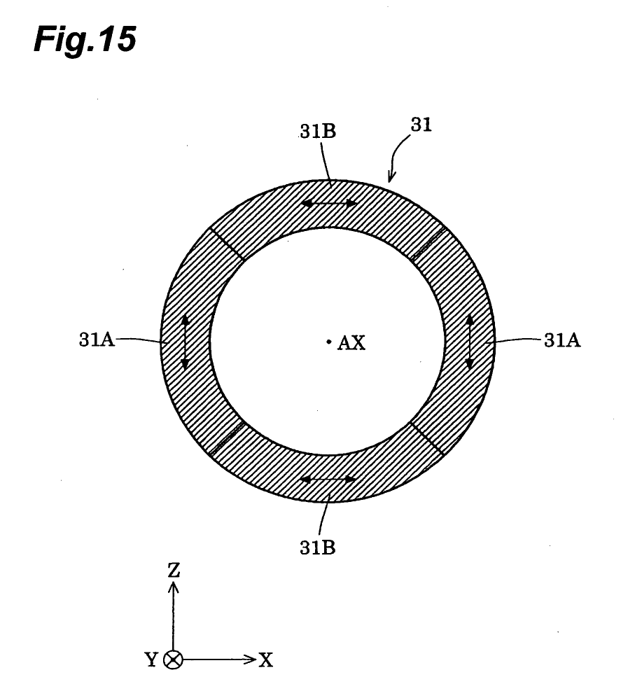

The first basic elements 6A have the thickness dA defined as follows: when linearly polarized light with the polarization direction along the Z-direction is incident thereto, they emit linearly polarized light with the polarization direction along a direction resulting from +180° rotation of the Z-direction around the Y-axis, i.e., along the Z-direction. In this case, therefore, the Z-direction is the polarization direction of beams passing through a pair of arcuate regions 31A formed by beams optically rotated by the pair of first basic elements 6A, in the annular secondary light source 31 shown in FIG. 15.

The second basic elements 6B have the thickness dB defined as follows: when linearly polarized light with the polarization direction along the Z-direction is incident thereto, they emit linearly polarized light with the polarization direction along a direction resulting from +90° rotation of the Z-direction around the Y-axis, i.e., along the X-direction. In this case, therefore, the X-direction is the polarization direction of beams passing through a pair of arcuate regions 31B formed by beams optically rotated by the pair of second basic elements 6B, in the annular secondary light source 31 shown in FIG. 15.

The polarization converting element 6 can also be obtained by combining the four basic elements separately made, or the polarization converting element 6 can also be obtained by forming the required uneven shape (level differences) in a rock crystal substrate of plane-parallel plate shape. In general, various modification examples can be contemplated as to the number, shape, optical properties, etc. of the basic elements constituting the polarization converting element 6. In order to enable implementation of normal circular illumination without retracting the polarization converting element 6 from the optical path, the polarization converting element 6 is provided with a circular central region 6C having the size not less than one third of the radial size of the effective region of the polarization converting element 6 and having no optical activity. The central region 6C herein may be made, for example, of an optical material without optical activity like silica, or may be simply a circular-aperture.

In the present embodiment, circumferential polarization (azimuthal polarization) annular illumination (modified illumination in which beams passing through the annular secondary light source are set in a circumferentially polarized state) is implemented in such a manner that the angular position of the crystal optical axis of the half wave plate 3b in the polarization state switch 3 is adjusted about the optical axis to make light of Z-directional polarization (linearly polarized light with the polarization direction along the Z-direction) incident to the diffractive optical element 4 for annular illumination whereby the Z-directionally polarized light is made incident to the polarization converting element 6. As a result, the annular secondary light source (annular illumination pupil distribution) 31 is formed on or near the rear focal plane of the cylindrical micro fly's eye lens 9, as shown in FIG. 15, and beams passing through the annular secondary light source 31 are set in the circumferentially polarized state.

In the circumferentially polarized state, beams passing through the respective arcuate regions 31A, 31B constituting the annular secondary light source 31 are changed into a linearly polarized state with the polarization direction aligned approximately with a tangent direction to a circle centered on the optical axis AX, at the center position along the circumferential direction of each arcuate region 31A, 31B. In the circumferential polarization (azimuthal polarization) annular illumination based on the annular illumination pupil distribution in the circumferentially polarized state, the light impinging upon the wafer W as a final surface to be illuminated is in a polarized state in which the principal component is S-polarized light. Here the S-polarized light is linearly polarized light with the polarization direction along a direction normal to the plane of incidence (or polarized light whose electric vector is vibrating in directions normal to the plane of incidence). The plane of incidence is defined as a plane including a normal to a boundary surface of a medium (surface to be illuminated: a surface of wafer W) at a point where the light reaches the boundary surface, and a direction of incidence of the light.

As a result, the circumferential polarization (azimuthal polarization) annular illumination achieves an improvement in the optical performance (the depth of focus and others) of the projection optical system and provides a good mask pattern image with high contrast on the wafer (photosensitive substrate). In general, not only in the case of the annular illumination, but also, for example, in the case of illumination based on a multi-pole illumination pupil distribution in the circumferentially polarized state, the light incident to the wafer W is in the polarized state in which the principal component is the S-polarized light, and a good mask pattern image with high contrast is obtained on the wafer W. In this case, a diffractive optical element for multi-pole illumination (dipole illumination, quadrupole illumination, octupole illumination, or the like) is set instead of the diffractive optical element 4 for annular illumination in the illumination optical path and the angular position of the crystal optical axis of the half wave plate 3b in the polarization state switch 3 is adjusted around the optical axis to make Z-directionally polarized light incident to the diffractive optical element for multi-pole illumination, whereby the Z-directionally polarized light is made incident to the polarization converting element 6.

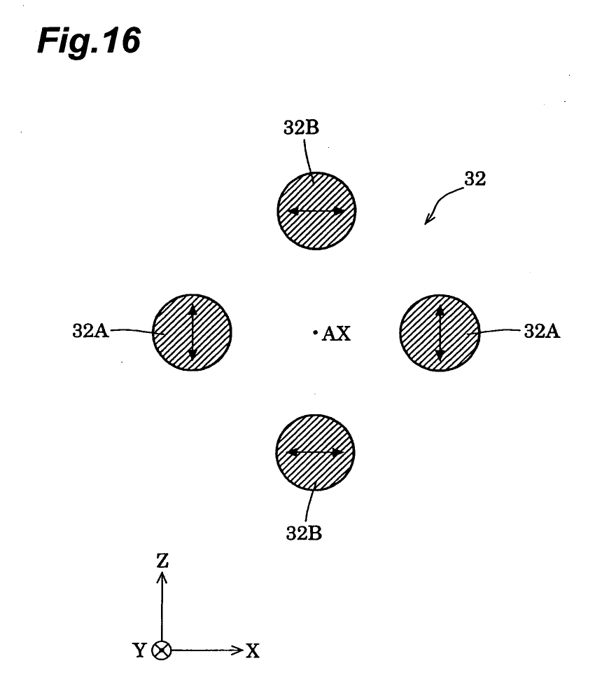

Specifically, for example, in the case of circumferentially polarized quadrupole illumination (modified illumination in which beams passing through quadrupolar secondary light sources are set in the circumferentially polarized state), the angular position of the crystal optical axis of the half wave plate 3b in the polarization state switch 3 is adjusted around the optical axis to make the Z-directionally polarized light incident to the diffractive optical element for quadrupole illumination whereby the Z-directionally polarized light is made incident to the polarization converting element 6. As a result, the quadrupolar secondary light sources (quadrupole illumination pupil distributions) 32 are formed, as shown in FIG. 16, on or near the rear focal plane of the cylindrical micro fly's eye lens 9 and beams passing through the quadrupolar secondary light sources 32 are set in the circumferentially polarized state. In the circumferentially polarized quadrupole illumination, beams passing through respective circular regions 32A, 32B constituting the quadrupolar secondary light sources 32 are changed into a linearly polarized state with the polarization direction aligned approximately with a tangent direction to a circle centered on the optical axis AX, at a center position along the circumferential direction of each circular region 32A, 32B.

An exposure apparatus of the present embodiment is provided with the optical integrator system OP having the same configuration as the second aspect shown in FIGS. 9A and 9B. Namely, the optical integrator system OP of the present embodiment has the cylindrical micro fly's eye lens (first optical integrator) 9 having a plurality of wavefront dividing elements two-dimensionally juxtaposed in the two directions of the Z-direction and the X-direction, and the prism array (second optical integrator) 10 having a plurality of wavefront dividing elements arranged in juxtaposition along the Z-direction, which are arranged in order from the entrance side of light. The cylindrical micro fly's eye lens 9, similar to the bidirectional fly's eye element 115 in FIG. 9A, is so constructed that rays obliquely incident to the center on the optical axis of the entrance surface of each wavefront dividing element are emitted in parallel with the element optical axis.

The cylindrical micro fly's eye lens 9, similar to the bidirectional fly's eye element 115 in FIG. 9A, is so constructed that the maximum exit angle of outgoing light made by light incident from the direction of the optical axis to the entrance surface of each wavefront dividing element becomes equal to the maximum exit angle of outgoing light made by light incident from oblique directions to the optical axis to the entrance surface. In this manner, the optical integrator system OP of the present embodiment is able to realize the high divergence angle characteristic required in the Z-direction corresponding to the perpendicular direction to scanning (Y-direction) and, in turn, the large exit NA required in the Z-direction, through cooperation of the cylindrical micro fly's eye lens 9 and the prism array 10.

Therefore, the present embodiment is able to ensure the required large exit numerical aperture and to form the desired illuminance distribution on the wafer W being the final surface to be illuminated, without need for excessively high accuracy for the surface shape of the optical surfaces 9ab, 9bb with the refracting action in the Z-direction corresponding to the perpendicular direction to scanning (Y-direction) in the cylindrical micro fly's eye lens 9. The illumination optical apparatus (1-13) of the present embodiment is able to illuminate the surface to be illuminated under a desired illumination condition, using the optical integrator system OP which ensures the required large exit numerical aperture and which forms the desired illuminance distribution on the surface to be illuminated. The exposure apparatus (1-WS) of the present embodiment is able to perform good exposure under a good illumination condition, using the illumination optical apparatus (1-13) which illuminates the surface to be illuminated under the desired illumination condition.

In the present embodiment, the movable optical members, which are arranged as movable in the optical path like the movable prism member in the conical axicon system 7 and the movable lens in the zoom lens 8, are located upstream of the optical integrator system OP. As these movable optical members move, the angles and angular range of light incident to the optical integrator system OP vary. However, even when the angles and angular range of light incident to the cylindrical micro fly's eye lens 9 vary, for example, due to the movement of the movable optical members located upstream of the optical integrator system OP, the angles and angular range of light incident to each wavefront dividing element of the prism array 10 can be kept constant by the action of the cylindrical micro fly's eye lens 9 and, in turn, a uniform illuminance distribution can be maintained on the wafer W being the final surface to be illuminated.

For fully exercising the action of the cylindrical micro fly's eye lens 9 in the present embodiment so as to achieve the effect of the present embodiment well, as described above, the spacing L12 between the exit surface of the cylindrical micro fly's eye lens 9 and the entrance surface of the prism array 10 can satisfy Condition (1) in the Z-direction. This is because the exposure apparatus of the step-and-scan method as in the present embodiment has the averaging effect of scanning exposure by which no significant issue is caused by some remaining illuminance unevenness in the scanning direction (scan direction: X-direction) in the still exposure region of the rectangular shape elongated along the Y-direction on the wafer W. In other words, illuminance unevenness to be suppressed in the still exposure region on the wafer W is that in the perpendicular direction to scanning (non-scan direction: Y-direction).

It is, therefore, important in the present embodiment that the spacing L12 between the exit surface of the cylindrical micro fly's eye lens 9 and the entrance surface of the prism array 10 can satisfy Condition (1) in the Z-direction corresponding to the perpendicular direction to scanning. In order to avoid the loss in light quantity in the optical integrator system OP, it is preferable that the spacing L12 between the exit surface of the cylindrical micro fly's eye lens 9 and the entrance surface of the prism array 10 can satisfy Condition (2) in the X-direction and in the Z-direction.

In the above-described embodiment, the cylindrical micro fly's eye lens 9 as the first optical integrator is composed of the first fly's eye member 9a and the second fly's eye member 9b and each of the first fly's eye member 9a and the second fly's eye member 9b has a plurality of entrance refracting surfaces of the cylindrical shape arranged in juxtaposition in the X-direction and a plurality of exit refracting surfaces of the cylindrical shape arranged in juxtaposition in the Z-direction. However, the first optical integrator does not have to be limited to it, but the first optical integrator can also be constructed of a single optical member having a plurality of entrance refracting surfaces of a curved shape two-dimensionally juxtaposed and a plurality of exit refracting surfaces of a curved shape two-dimensionally juxtaposed, for example, like the bidirectional fly's eye element 115 of FIG. 9A.

The above-described embodiments use the prism array 10 as the second optical integrator. However, a diffractive optical element, a microlens array, or the like can also be used instead of the prism array 10, as described previously.

The foregoing embodiments are applications of an embodiment of the present invention to the exposure apparatus for implementing scan exposure of a pattern in each exposure area of a wafer in accordance with the so-called step-and-scan method, while moving the mask and the wafer relative to the projection optical system. However, without having to be limited to this, an embodiment of the present invention can also be applied to exposure apparatus for sequentially implementing exposure of a pattern in a shot area of a wafer in accordance with the so-called step-and-repeat method by performing one-shot exposure while two-dimensionally driving and controlling the wafer.

The exposure apparatus according to the foregoing embodiments is manufactured by assembling various sub-systems containing their respective components as set forth in the scope of claims in the present application, so as to maintain predetermined mechanical accuracy, electrical accuracy, and optical accuracy. For ensuring these various accuracies, the following adjustments are carried out before and after the assembling: adjustment for achieving the optical accuracy for various optical systems; adjustment for achieving the mechanical accuracy for various mechanical systems; adjustment for achieving the electrical accuracy for various electrical systems. The assembling blocks from the various sub-systems into the exposure apparatus include mechanical connections, wire connections of electric circuits, pipe connections of pneumatic circuits, etc. between the various sub-systems. It is needless to mention that there are assembling blocks of the individual sub-systems, before the assembling blocks from the various sub-systems into the exposure apparatus. After completion of the assembling blocks from the various sub-systems into the exposure apparatus, overall adjustment is carried out to ensure various accuracies as the entire exposure apparatus. The manufacture of exposure apparatus can be performed in a clean room in which the temperature, cleanliness, etc. are controlled.

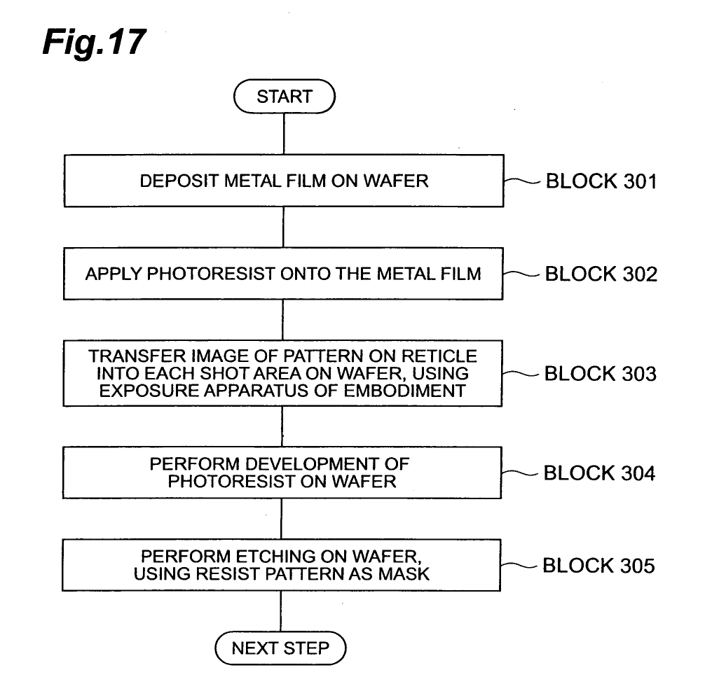

The exposure apparatus according to the above-described embodiments can manufacture microdevices (semiconductor devices, imaging devices, liquid-crystal display devices, thin-film magnetic heads, etc.) through a process of illuminating a mask (reticle) by the illumination optical apparatus (illumination block) and exposing a photosensitive substrate with a transfer pattern formed in a mask, by the projection optical system (exposure block). An example of a method for obtaining semiconductor devices as microdevices by forming a predetermined circuit pattern in a wafer or the like as a photosensitive substrate by means of the exposure apparatus of the above embodiments will be described below with reference to the flowchart of FIG. 17.

The first block 301 in FIG. 17 is to deposit a metal film on each wafer in one lot. The next block 302 is to apply a photoresist onto the metal film on each wafer in the lot. The subsequent block 303 is to use the exposure apparatus of the above embodiments to sequentially transfer an image of a pattern on a mask into each shot area on each wafer in the lot through the projection optical system of the exposure apparatus. The subsequent block 304 is to perform development of the photoresist on each wafer in the lot and the next block 305 is to perform etching using the resist pattern on each wafer in the lot as a mask, and thereby to form a circuit pattern corresponding to the pattern on the mask, in each shot area on each wafer. Thereafter, devices such as semiconductor devices are manufactured through blocks including formation of circuit patterns in upper layers. The above-described semiconductor device manufacturing method permits us to obtain the semiconductor devices with extremely fine circuit patterns at high throughput.

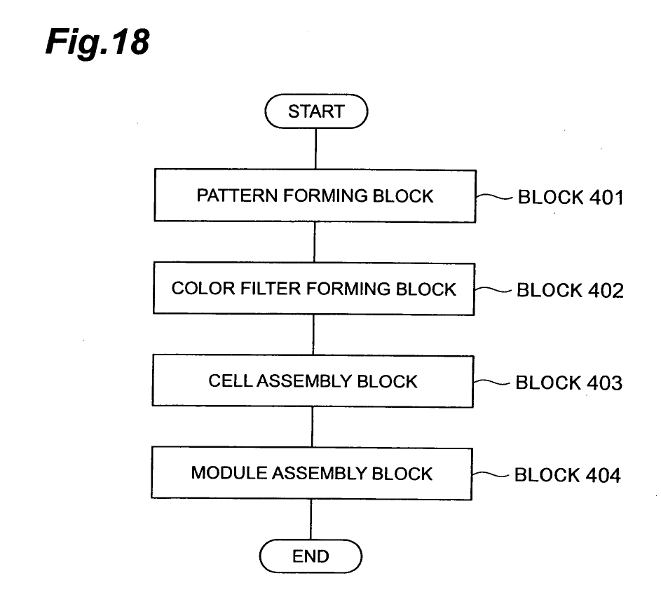

The exposure apparatus of the above embodiments can also manufacture a liquid-crystal display device as a microdevice by forming predetermined patterns (circuit pattern, electrode pattern, etc.) on plates (glass substrates). An example of a method in this case will be described below with reference to the flowchart of FIG. 18. In FIG. 18, a pattern forming block 401 is to execute the so-called photolithography block of transferring a pattern of a mask onto a photosensitive substrate (a glass substrate coated with a resist or the like) by means of the exposure apparatus of the above embodiments. This photolithography block results in forming a predetermined pattern including a large number of electrodes and others on the photosensitive substrate. Thereafter, the exposed substrate is processed through each of blocks including a development block, an etching block, a resist removing block, etc. whereby the predetermined pattern is formed on the substrate, followed by the next color filter forming block 402.

The next color filter forming block 402 is to form a color filter in which a large number of sets of three dots corresponding to R (Red), G (Green), and B (Blue) are arrayed in a matrix pattern or in which sets of filters of three stripes of R, G, and B are arrayed in the horizontal scan line direction. After the color filter forming block 402, a cell assembling block 403 is executed. The cell assembling block 403 is to assemble a liquid crystal panel (liquid crystal cell) using the substrate with the predetermined pattern obtained in the pattern forming block 401, the color filter obtained in the color filter forming block 402, and others.

In the cell assembling block 403, the liquid crystal panel (liquid crystal cell) is manufactured, for example, by pouring a liquid crystal into between the substrate with the predetermined pattern obtained in the pattern forming block 401 and the color filter obtained in the color filter forming block 402. The subsequent module assembling block 404 is to attach various components such as electric circuits and a backlight for display operation of the assembled liquid crystal panel (liquid crystal cell) to complete the liquid-crystal display device. The above-described manufacturing method of the liquid-crystal display device permits us to obtain the liquid-crystal display device with extremely fine circuit patterns at high throughput.

The aforementioned embodiments used the ArF excimer laser light (the wavelength: 193 nm) or the KrF excimer laser light (the wavelength: 248 nm) as the exposure light, but the exposure light does not have to be limited to these: an embodiment of the present invention can also be applied to any other appropriate laser light source, e.g., an F₂ laser light source for supplying the laser light at the wavelength of 157 nm.

The aforementioned embodiments were the applications of the embodiments of the present invention to the optical integrator system used in the illumination optical apparatus of the exposure apparatus, but, without having to be limited to this, the embodiments of the present invention can also be applied to any optical integrator system used in commonly-used optical apparatus. The foregoing embodiments were the applications of the embodiments of the present invention to the illumination optical apparatus for illuminating the mask or the wafer in the exposure apparatus, but, without having to be limited to this, the embodiments of the present invention can also be applied to commonly-used illumination optical apparatus for illuminating a surface to be illuminated except for the mask or the wafer.

The invention is not limited to the fore going embodiments but various changes and modifications of its components may be made without departing from the scope of the present invention. Also, the components disclosed in the embodiments may be assembled in any combination for embodying the present invention. For example, some of the components may be omitted from all components disclosed in the embodiments. Further, components in different embodiments may be appropriately combined.

What is claimed is:

1. An optical integrator system comprising: a first optical integrator including a plurality of first wavefront dividing elements arranged in juxtaposition along a predetermined direction; and a second optical integrator including a plurality of second wavefront dividing elements arranged in juxtaposition along the predetermined direction, said first optical integrator and said second optical integrator being arranged in order from an entrance side of light;
wherein each of the first wavefront dividing elements is so constructed that rays obliquely incident to a center on an optical axis of an entrance surface of the first wavefront dividing element are emitted in parallel with the optical axis from the first wavefront dividing element, and
wherein each of the second wavefront dividing elements is so constructed that rays obliquely incident to a center on an optical axis of an entrance surface of the second wavefront dividing element are emitted obliquely to the optical axis from the second wavefront dividing element.

2. The optical integrator system according to claim 1, wherein each of the first wavefront dividing elements is so constructed that a maximum exit angle (half angle) of light from the first wavefront dividing element made by light incident along a direction of the optical axis to the entrance surface of the first wavefront dividing element becomes equal to a maximum exit angle (half angle) of light from the first wavefront dividing element made by light incident from an oblique direction to the optical axis to the entrance surface of the first wavefront dividing element.

3. The optical integrator system according to claim 2, wherein the first optical integrator comprises a single optical member, and wherein the single optical member includes a plurality of entrance refracting surfaces of a curved shape two-dimensionally juxtaposed, and a plurality of exit refracting surfaces of a curved shape two-dimensionally juxtaposed.

4. The optical integrator system according to claim 2, wherein the first optical integrator comprises a first optical member and a second optical member arranged in order from the entrance side of light, and wherein each of the first optical member and the second optical member includes a plurality of entrance refracting surfaces of a cylindrical shape arranged in juxtaposition along one direction, and a plurality of exit refracting surfaces of a cylindrical shape arranged in juxtaposition in one direction.

5. The optical integrator system according to claim 3, wherein a spacing L12 between an exit surface of the first optical integrator and an entrance surface of the second optical integrator satisfies the condition of P2/(2×tan θ)<L12,
where P2 is a pitch along the predetermined direction of the second wavefront dividing elements, and θ a maximum exit angle (half angle) along the predetermined direction of light from the exit refracting surfaces of the single optical member or the second optical member.

6. The optical integrator system according to claim 5, wherein the spacing L12 satisfies the condition of L12<D2/(2×tan θ),
where D2 is a length along the predetermined direction of the entrance surface of the second optical integrator.

7. The optical integrator system according to claim 5,
wherein the pitch P2 along the predetermined direction of the second wavefront dividing elements is substantially different from an integral multiple of a pitch P1 along the predetermined direction of the exit refracting surfaces of the single optical member or the second optical member.

8. The optical integrator system according to claim 2, wherein the first optical integrator comprises:
a first optical member including a plurality of entrance refracting surfaces of a cylindrical shape arranged in juxtaposition along the predetermined direction, and a plurality of exit refracting surfaces of a cylindrical shape arranged in juxtaposition along the predetermined direction; and
a second optical member including a plurality of entrance refracting surfaces of a cylindrical shape arranged in juxtaposition along a direction intersecting with the predetermined direction, and a plurality of exit refracting surfaces of a cylindrical shape arranged in juxtaposition along a direction intersecting with the predetermined direction.

9. The optical integrator system according to claim 8, wherein the second optical integrator is arranged downstream of the first optical member.

10. The optical integrator system according to claim 8, wherein a spacing L12 between an exit surface of the first optical member and an entrance surface of the second optical integrator satisfies the condition of P2/(2×tan θ)<L12,
where P2 is a pitch along the predetermined direction of the second wavefront dividing elements, and θ a maximum exit angle (half angle) along the predetermined direction of light from the exit refracting surfaces of the first optical member.

11. The optical integrator system according to claim 10, wherein the spacing L12 satisfies the condition of L12<D2/(2×tan θ),
where D2 is a length along the predetermined direction of the entrance surface of the second optical integrator.

12. The optical integrator system according to claim 10,
wherein the pitch P2 along the predetermined direction of the second wavefront dividing elements is substantially different from an integral multiple of a pitch P1 along the predetermined direction of the exit refracting surfaces of the first optical member.

13. The optical integrator system according to claim 1, wherein the second optical integrator includes a prism array, a diffractive optical element, or a microlens array.

14. An illumination optical apparatus for illuminating a surface to be illuminated by light from a light source, the illumination optical apparatus comprising the optical integrator system as set forth in claim 1, said optical integrator system being arranged in an optical path between the light source and the surface to be illuminated.

15. The illumination optical apparatus according to claim 14, comprising a movable optical member movably arranged in an optical path between the light source and the optical integrator system.

16. An exposure apparatus comprising the illumination optical apparatus as set forth in claim 15, for illuminating a predetermined pattern, whereby a photosensitive substrate is exposed with the predetermined pattern.

17. The exposure apparatus according to claim 16, comprising a projection optical system for forming an image of the predetermined pattern on the photosensitive substrate, wherein the predetermined pattern and the photosensitive substrate are moved along a scanning direction relative to the projection optical system whereby the predetermined pattern is projected onto the photosensitive substrate to effect projection exposure of the photosensitive substrate with the predetermined pattern.

18. The exposure apparatus according to claim 17, wherein the predetermined direction in the optical integrator system corresponds to a direction perpendicular to the scanning direction on the photosensitive substrate.

19. A device manufacturing method comprising:
exposing the photosensitive substrate with the predetermined pattern, using the exposure apparatus as set forth in claim 16; and
developing the exposed photosensitive substrate.
